(19) United States
(12) Patent Application Publication
(10) Pub. No.: US 2002/0087696 A1
(43) Pub. Date: Jul. 4, 2002

(54) Automatic management systemfor communications networks

(76) Inventor: Philippe C. Byrnes, Palo Alto, CA (US)

Correspondence Address: Aldo J. Test, FLEHR HOHBACH TEST ALBRITTON & HERBERT LLP, Suite 3400, Four Embarcadero Center, San Francisco, CA, 94111-4187, US

(21) Appl. No.: 10/032,749

(22) Filed: Dec. 27, 2001

Related U.S. Application Data
(60) Provisional application No. 60/258,774, filed on Dec. 28, 2000.

(51) Int. Cl. G06F 15/173

(52) U.S. Cl. 709/226

(57) ABSTRACT

An automatic control system for monitoring and controlling bandwidth and workload in a communications network.

### RELATED APPLICATIONS

This application claims priority to Provisional Application Ser. No. 60/258,774 filed Dec. 28, 2000.

### BRIEF DESCRIPTION OF THE INVENTION

This invention relates generally to the automatic monitoring and control of performance and quality of service variables including response time, throughput, and utilization as well as availability variables including reliability and maintainability of discrete event systems such as communication networks and more particularly to the analysis, implementation, and execution of the tasks entailed in managing communications networks.

### BACKGROUND OF THE INVENTION

A computer communications network is a composite discrete event system (DES) made up of two classes of servers: links, which effect the actual transportation of data between source and destination end nodes; and intermediate nodes, which relay data between links, thereby effecting the concatenation of links to provide end-to-end transport of data. Other terms of art for an intermediate node include intermediate system and relay. This concatenation, which is generally referred to as routing or forwarding, may be static or dynamic. Static routing relies on pre-computed routing or forwarding tables that do not change even if there are changes in the state of the network's available links or intermediate nodes. Dynamic routing, in contrast, alters the routing or forwarding tables as feedback is received about changes in the state or topology of the network, possibly including information on the maximum available bandwidth or service rate of the network's links. When a network has been designed with redundant links, a principal advantage of dynamic routing is that it allows recovery from faults that might otherwise disable end-to-end transport of data.

The challenge of controlling performance variables such as response time, jitter, and throughput—generally referred to collectively as Quality of Service (QoS)—is that topology alone is inadequate to the task. As is well-known from queueing theory, bandwidth or service rate is just one of several variables that determine the performance of a discrete event system (DES), i.e., queueing system. Other variables include the traffic arrival rate(s), the storage available for queued traffic, and the scheduling discipline(s) used to determine the sequencing for execution of incoming requests for service, i.e., the forwarding of packets. Topology-adaptive routing protocols deliberately ignore these other variables when calculating the forwarding tables to be used by the intermediate nodes in a computer network. The forwarding tables that are calculated as part of the routing process are optimized with respect to topology and/or bandwidth but no attempt is made to include traffic state information or similar data about congestion in the network.

There are several reasons for advancing a new automatic network management system, most importantly the current systems are inadequate to task of managing the next generation of internetworks, which must be self-tuning as well as self-repairing. By monitoring traffic intensity (and its constituents, workload arrival and server bandwidth), throughput, and particularly response times, the managers of these networks will automatically balance workload to bandwidth, increasing the latter in reaction to growth in the former (for example, perhaps meeting temporary surges through buying bandwidth-ondemand much as electric utilities do with the power grid interconnect).

Response time, especially, is worth mentioning as a driving force in the next generation of intemets: the visions of multimedia (voice and video) traffic flowing over these intemets will only be realized if predictable response times can be assured. Otherwise, the effects ofjitter (variable delays) will militate against multimedia usage. All of this points to the incorporation of the techniques and models of automatic control systems in the next generation of intemetworking protocols.

Reduced to essentials, we are interested in controlling the performance of a discrete event (aka queuing) system. Later we'll explain that the server is the computer network that is a collective of individual servers and the client is the collective set of computers seeking to exchange data; that is in the case at hand, the plant is the communications network and its clients (i.e., digital computers), and the function of the control system is to respond to changes in the network and/or its workload by modifying one or both of these. For now, however, let's keep it simple.

The performance of a discrete event system can be parameterized by such measures/variables as delay, throughput, utilization, reliability, availability, and so on. These are all determined by two (usually random) processes: the rate at which workload arrives from the client and the rate at which the workload is executed by the server. This means that, for even the simplest discrete event (i.e., queueing) system, there are two degrees of freedom to the task of controlling the performance: the arrival and service rates.

The state of a discrete event plant is determined by the state of the client and the state of the server (leaving aside for now the question of queue capacity and associated storage costs). In the terminology of queueing theory, the client is characterized by the arrival process/rate. The arrival rate generally is shorthand for the mean interarrival time, and is denoted by the Greek letter more sophisticated statistical measures than simple means are sometimes used. Real-world clients generate requests for service (work) that can be described by various probabilistic distributions. For reasons of mathematical tractability the exponential distribution is most commonly used.

In addition, we must specify what the client requests. A client must, of necessity, request one or more types of tasks (this can include multiple instances of the same task). The task type(s) a client may request constitute its task set. Two clients with the same task set but with different arrival processes will be said to differ in degree. Two clients with different task sets will be said to differ in kind.

To manage the server in a discrete event plant amounts to managing its bandwidth, i.e. its service rate, and by extension its task set. When we speak of bandwidth we mean its effective bandwidth (BWₑ), which is the product of its nominal bandwidth (BWₙ) and its availability A. Availability, in turn, is determined by the server's reliability R, typically measured by its Mean Time Between Failures (MTBF) and its maintainability M, typically measured by its Mean Time To Repair (MTTR). A “bandwidth manager”—arguably a more descriptive term than “server manager” or “service rate manager”—can therefore actuate the bandwidth of a server by actuating its nominal bandwidth, its reliability, or its maintainability.

Implementing the least-cost server entails making a set of tradeoffs between these parameters. For example, a server with a high nominal bandwidth but low availability will have the same average effective bandwidth as a server with a low nominal bandwidth but high availability. Similarly, to attain a given level of average availability there is a fundamental tradeoff to be made between investing in reliability (MTBF) and maintainability (MTTR). A highly reliable server with poor maintainability (i.e., a server that seldom is down but when it is down is down for a long time) will have the same availability as a server that is less reliable but which has excellent maintainability (i.e., is frequently down but never for a long time). In both these tradeoffs, very different servers can be implemented with the same averages, although it should be noted that the standard deviations will be very different.

A server's bandwidth (and/or other parameters) is actuated first in its design and implementation. Implementation is an actuation of the server's nominal bandwidth from zero, which is what it is before it exists, to some positive value; and its task set from null to non-empty. Up to this point, the server does not exist. Although it seems obvious to say, bandwidth management is open-loop in the design phase since there is nothing to measure. Based on measurements and/or estimates of the client's demand, management will schedule the actuation of the server and its components.

After this there is a server extant, and this means that bandwidth management may be, if desired, closed-loop. The next instance of actuating a server's bandwidth general occurs after a fault. As we remarked above, all servers have finite reliability. A server that is disabled by a fault has a reduced bandwidth: a partial fault may reduce the bandwidth but still leave a functioning server while a fatal fault reduces the bandwidth to 0. Restoring some or all of the server's lost bandwidth is obviously an instance of bandwidth management.

This task is typically divided into three components: fault detection, isolation, and repair (or replacement). Of these, fault detection involves measuring state and/or output variables to detect anomalous conditions. For example, high noise levels is a communications line can indicate a variety of faults or vibrations at unusual frequencies can mean mechanical system faults. Fault isolation generally requires estimators since it entails a process of inference to go from the “clues” that have been measured to identifying the failed component(s) of the server. The actuation of the server is effected in the last phase, repair or replacement. The reason this is bandwidth actuation is that after a successful repair the bandwidth of the server is restored to the status quo ante.

It might seem from the above that a bandwidth manager must be closed-loop to effect maintenance; and while feedback undoubtedly reduces the time from the occurrence of a fault to the server having its bandwidth restored, there are circumstances under which open-loop maintenance policies may be used instead. Such policies as age-replacement, block replacement, etc., all require the bandwidth manager to replace components of the server irrespective of their condition; such a policy will result in any failed components being eventually replaced, and many failures being prevented in the first place, albeit at the cost of discarding many components with useful lifetimes left. (For further discussion of various maintenance policies either Goldman and Slattery or Barlow and Proschan¹.) ¹ Goldman, A. and Slattery, T., Maintainability, A Major Element of System Effectiveness, John Wiley & Sons, 1964; Barlow, R. and Proschan, F., Mathematical Theory of Reliability, John Wiley & Sons, 1965.

Typically, however, bandwidth managers responsible for maintaining servers are closed-loop. Indeed, in the absence of sensors and estimators to infer the server's condition, the incidence of latent faults will only increase. Therefore, a major part of most bandwidth managers is the instrumentation of the server so as to monitor its condition. In fact, since it can be even argued that the maintainability of a server is one measure of the service rate of bandwidth manager that is responsible for fault detection, isolation, and recovery (repair or replacement), an investment in instrumentation that reduces downtime increases the bandwidth of the bandwidth manager.

It is also worth noting that most bandwidth managers maintaining geographically distributed servers are implemented not monolithically but rather in a “multiechelon” architecture: the first echelon consists of limited instrumentation capabilities for detecting most faults but not necessarily isolating their causes or effecting the corresponding repairs. This simple cases can be resolved at the first echelon while more difficult cases are transported back to “rear” echelons where more sophisticated instrumentation and repair servers are located. The advantages of this approach are that it offers lower costs than a monolithic approach which would require the same sophistication at each location that had servers to be maintained.

Finally we come to deliberately upgrading or improving the server's bandwidth, as opposed to merely restoring it after a fault. There are two basic degrees of freedom here: the bandwidth of the server and its task set. Consider first the instance where we have a server that can execute multiple types of tasks but we can change neither its total bandwidth nor its task set. Holding both these constant we can still change the bandwidth allocated to each task—this is still a meaningful change. An example would be to alter the amount of time allocated to servicing the respective queues of two or more competing types of tasks, such as different classes of service or system vs. user applications, etc. Since we are not changing the tasks the server can execute, the “before” and “after” servers differ only in degree, not kind. We will therefore refer to this as actuation of degree.

Another variant of actuation of degree is possible, namely holding the server's task set constant but now changing the total bandwidth of the server. An example would be to replace a communications link with one of higher speed, for example going from 10 BaseT to 100 BaseT, but not adding any additional stations. The task set would be unchanged but the bandwidth would be increased. We refer to this as actuation of degree as well but to distinguish the two cases we'll call this actuation of degree₂ and the first type actuation of degree₁. Of course, if a server can execute only one task, obviously, this collapses to a single choice, namely the actuation of degree₂.

Changing a server's task set does transform it into a different type of server and we call this last type of change actuation of kind. Changing the task set of a server often entails significant alteration of its design and/or components. Of course, it can be as simple as adding a new station to a LAN. Generally, though, actuation of kind is the most complicated and extensive of the changes possible in bandwidth management.

It should be noted that changing the nominal service rate and/or task set is not something undertaken easily or often. In some cases servers have two or more normal service rates that a bandwidth manager can actuate between, perhaps incurring higher costs or increased risk of faults as the price of the higher bandwidth. For example, increasing the signal levels in communications channels can improve the noise resistance but reduce the lifetime of the circuits due to increased heat. An example of a server that has several service rates is a modem that can operate at several speeds, depending on the noise of the communications channel.

We should also remark that for many servers, particularly those which are complex and composed of many component servers, the key parameters may not be known or known adequately and must be measured. In these cases, it may be up to bandwidth management to monitor (measure and/or estimate) the three key random variables/parameters: the service time process, the reliability process, and the maintainability process. If the server is composite then the there is the option of estimating these parameters for its components and, with knowledge of its composition, estimating the topology of the composite; or its internal details can be simply elided, lumping the components together and treating them as one entity.

Now we come to workload managers. The need for, the very existence of, workload management is a concession to the inescapable limits in any implementable server. This means, as we just discussed, accommodating a server's finite bandwidth and reliability. And, just as we identified three levels of actuation for changing the task set and/or service rate(s) of a server, so there are three levels of workload actuation.

The first level of workload management is access and flow control. A server with limited (i.e., finite) bandwidth can not service an unlimited number of Requests for Service. (In addition, although we did not dwell on it in the state description above, the limits on the queue size often constitute even greater constraints than the fact that bandwidth is necessarily finite.) A basic workload manager will actuate only the interarrival distribution, i.e. the arrival process. We will refer to this as actuation of degree₁.

There are various mechanisms that can be used to actuate the arrival rate so as to allocate scarce resources (bandwidth, queue space, . . . ), which can broadly be divided into coercive and noncoercive. Coercive mechanisms include tokens, polling, and other involuntary controls. To change the arrival rates of workload can also be done by buffering and/or discard, either in-bound or out-bound. Noncoercive mechanisms revolve around issues of pricing and cost: raising “prices” to slow down arrivals, lowering them to increase arrivals. It should be noted that coercive and noncoercive mechanisms can be combined.

Examples of basic workload actuation (actuation of degree₁) abound in computer communications. The access control mechanisms in Ethernet requires each station (i.e., client) to sense the status of the shared bus and, if it isn't free, to stop itself from transmitting. SDLC uses a polling protocol with a single master that allocates the channel to competing clients. Token Bus and Token Ring (802.4 and 802.5) use token passing to limit access.

By altering the arrival rates at which the work (RFSs) arrives, workload management can avoid saturating limited queues, balance out workload over a longer period, and avoid the possibility of a contention fault, when two or more competing clients prevent any from having their requests being successfully executed.

One of the most important types of workload actuation of degree extends beyond simply deferring or accelerating the rate of arrival of Requests for Service. If the original RFS is replicated into two or more RFSs, this is what we will call actuation of degree₂. The importance of this replication may not seem obvious but the whole concept of time-slicing that lays behind packet switching is in fact actuation of degree₂ with the plant is divided for piecemeal execution. (Packet-switching works by dividing a message into smaller units called packets—see Part III for more on the technology and origins of the term.)

In the case of packet switching this means sharing scarce communications bandwidth by means of dividing the bandwidth of a transporter into time-slices, also called quanta; the result of this division are packets. That is to say, given a transporter of finite bandwidth, it follows that in a finite interval of time only a finite amount of data could be transported. Consider what it means to time-slice a transporter of bandwidth M symbols per second (=Mk bits per second, where there are k bits/symbol). If we establish the time-slicing interval (quantum) as 1/J seconds then the maximum amount of data that can be transported in that interval is Mk/J bits. This is the maximum packet size. Equivalently, if we limit the maximum unit of plant (data) that can be transported with one RFS we effectively establish an upper bound on the quantum that can be allocated to an individual client.

A workload manager actuating an RFS from one type of task to another occurs with layered implementations where the implementation details of a server are abstracted from a client. For example, when the server is a composite transporter then this de-aliasing is precisely the concatenation task that we frequently call routing (although it could be bridging, switching, etc.). The server S₁ in the figure could be an IP network, with S₂, S₃, . . . Sₖ as component networks and the workload manager is a router (bridge, switch, . . . ). In other words, workload actuation of kind is precisely the relaying function. This brings us to one of our principal results, which we will explore in detail in the chapters of Part II: namely, that the composition of two or more servers is necessarily effected by a workload manager. In this instance we say that the workload manager is a proxy client for the actual client.

An example of an intemetwork with relays R₁, R₂, R₃, and R₄ (which could be bridges, routers, switches, or some combination). The transport task N₁>N₂ is realized by a set of component transport tasks between pairs of MAC addresses (and, internal to the relays, between LAN interfaces):

(1)2001.3142.3181 −>4000.1302.9611

(1′) Across bus(ses) of R₁

(2) 0000.3072.1210 −>0000.1197.3081

(2′) Across bus(ses) of R₂

(3) 0000.1AA2.3901 −>0000.3080.2128

(3′) Across bus(ses) of R₃

(4) 0000.3084.2199 −>0000.3080.C177

(4′) Across bus(ses) of R₄

(5) 0000.3080.C178 −>0000.1118.3112

There is an issue remaining to be considered, namely the interaction of the bandwidth and workload managers. Of course, it is possible to have a monolithic manager responsible for both workload and bandwidth actuation. However, even in this case there remains the question of which variable to actuate for controlling the performance variables of the discrete event system. A number of problems in management stem directly from the fact that the objectives of the respective control systems can not be easily decoupled; the coupling is due to the presence of performance variables in any optimality criteria used to optimize the control of service rates and traffic respectively. Since performance is a joint product of service and traffic rates, specifically the traffic intensity, the two indirectly influence each other.

In some instances, for example fault recovery, it may be that both variables are actuated: beyond the case we discussed earlier where fault recovery is effected by retransmission, there are circumstances where bandwidth management will attempt to restore the lost bandwidth while workload management attempts to reduce the arrival rate(s) until this happens.

This means that the coupled schedulers must cooperate. One way to establish the rules of this cooperation is to define another scheduler that is a “master” of the schedulers of the two managers. This master scheduler receives the same state and parameter feedback from the respective monitoring servers (sensors and estimators) and using this information determines the targets that the workload and bandwidth managers will seek to attain with their respective plants.

The master scheduler can decide these targets economically: if the utility to the client(s) of the service(s) provided by the server(s) is known and if the cost function of providing the service(s) is likewise known then, using the well-known formula for profit maximization MR=MC (from marginal economic analysis²). In other words, the master scheduler would set the bandwidth target such that the marginal revenue from client RFSs equals the marginal cost of providing the bandwidth; and the bandwidth scheduler would then seek to keep the server at that level. Difficulties in applying MR=MC include defining cost function and establishing price elasticity for the demand from the clients. ² See, for example, Nicholson, W., Microeconomic Analysis, 3rd Edition, Dryden Press, 1985

What this means is that when the server is a transport network, it is by definition spatially distributed; and the workload and the server can not be adequately represented by lumped-parameter equations. Traffic intensity, the ratio of arrival to service rate, is no longer a single number dependent only on time: it now depends on location as well, that is to say space. To the extent we wish to be mathematically accurate, partial differential and/or difference equations must be used. If a computer network is nothing more than a server that transports data, it is nonetheless a server with distributed parameters and other complexities sufficient to make the task of managing it interesting.

Each layer encapsulates its predecessor, abstracting implementation details and allowing a client to request services without necessarily knowing any detail of implementation. The nature of a layered communications architecture is that intelligence is embedded within each layer to present an abstracted service to its immediately superior layer. The top layer, which provides the interface for the communicating applications, varies according to the different protocols used; but in the world of the Internet the top layer is generally TCP and/or UDP. Whatever the top layer, as the client's request and accompanying data proceeds down the protocol stack through the lower layers, the request and generally the data are both transformed into new Requests for Service and into multiple pieces, respectively. This is why, in the layered model of communications protocols such as the SNA, TCP/IP, or OSI, the n-1st layer can be a transporter to the nth layer, which is a proxy client for the real client, at the same time that the nth layer is a transporter to the n+1st layer, again a proxy client.

Although we haven't stressed the fact, the definitions of server have all been “object-oriented” specifically, there is adherence to the principle of inheritance. In particular, the significance of this is that a composite server, such as a transporter plus a manager, may “inherit” the task(s) of the component server. In the case at hand, this means that a transporter plus and manager is a transporter: the service rates may be different, indeed the tasks may have been actuated, but they are nonetheless transportation tasks. This is the reason layering works: because, when all the layer logic (really, management logic as we've demonstrated and will show further in subsequent chapters) is stripped away, we are still left with a transporter that moves data from one location to another.

The analogy with a routing protocol is apt. Assume each relay (workload manager) has a bandwidth manager as well, measuring the condition of the local channels and the relay itself. This local state information is then broadcast or otherwise disseminated to the other relays, each of which uses the sum of this local information to reconstruct the global topology of the network. Such reconstruction is clearly the task of an estimator, and this points out one part of a routing protocol: the presence of an bandwidth estimator to put together the “big picture”. (Seen another way, a routing protocol's collection of topology information is a type of configuration management; this tells us something about the functional areas of network management which we'll return to in the next section.) The reason for collecting local topology (state) information and reconstructing the global topology is to efficiently use the components of the network—the data links and relays. Recall that the challenge of “computer networking” is knitting together multiple transport actuators. When it comes to this concatenation, the important question is—what is the path? This brings us to the major second part of a routing protocol: scheduling. Determining the best next stage in a multistage transporter can be done several ways, such as distance-vector or link-state (more on these later in the book), but in any case this is the responsibility of a workload scheduler.

A routing protocol can be decomposed into a workload scheduler and a bandwidth estimator (at a minimum—other management components are usually present). This discussion of routing protocols gives us the opportunity to touch on something often ignored: the cost of management. Management is not free. There is a significant expense to the various management servers necessary to monitor and control the network. The question arises: how much should be invested in management servers and how much instead should be devoted to additional servers for the network itself? An answer to this depends on the relative contributions to performance obtained from added management bandwidth vs. added transport bandwidth.

These costs to managing a network come in two varieties: the fixed costs, generally from the implementation of the management servers, and the variable costs that are incurred when these servers execute their respective management tasks. For example, monitoring a communications network requires instrumenting it, that is implementing sensors to measure the network's state, as least as it is reflected in the output (that is, mensurable) variables. The “up-front” cost, of implementing the sensors, is fixed: whether these servers are monitoring/(measuring)/executing or not, they still must be “paid” for.

On the other hand, certain costs accrue from operating the sensors: power is consumed, memory and CPU cycles may be used that might otherwise be employed in executing communications and other tasks, and, not least, the measurements made by these sensors usually are/must be sent to management decision servers (estimators and/or schedulers) located elsewhere in the network. This last cost can be particularly significant because management traffic (consisting of such things as these measurements from sensors, estimates from estimators, and commands from schedulers) either competes with the user traffic for the available bandwidth of the network or must flow over its own dedicated communications network.

An example of this is the routing protocol's topology data exchange, which uses network bandwidth that is consequently unavailable for transporting end-user data. And unfortunately, as the size of the internetwork grows, the amount of topology data exchanged grows even faster, in fact as O(n²). To reduce this quadratic scaling various techniques have been devised which generally speaking involve aggregation of routing information, with a concomitant loss of granularity. This modularization in fact results precisely in the hybrid locally central, globally distributed decision structure we referred to above.

One design objective, therefore, when planning the monitoring network: reduce the volume and frequency of measurements that must be sent over the network. there are two types of sampling that can reduce this volume: spatial sampling and time sampling. Sampling in time brings us to the sampled data control system. Spatial sampling is considerably more complex and is applicable to distributed parameter systems such as computer networks.

As was noted earlier, a principal catalyst for developing the MESA model of management bandwidth versus workload, actuation of kind and actuation of degree (both types)—was to eliminate from network theory certain false dichotomies, that is to say artificial distinctions based on practice and precedence, perhaps, but not well-founded in analysis. Conspicuous among these are the prevailing wisdom that protocol issues are distinct from management issues; and that the events of a network's lifecycle constitute distinct and dissimilar phases.

In the development of computer networks and their associated protocols, at an early point there was a division of tasks into two categories: those that were part of enabling computers to send and receive data among themselves and those that were part of managing the enabling entities, that is managing the communications networks themselves. The first of these we have come to call computer networking, the second management. And yet, a network management system should encompass all of these since, apart from the simple transportation of the plant as it was received from the client, all the other tasks executed in a computer network are management tasks.

Another benefit to the network management system is that it encompasses the whole network lifecycle and unifies its activities, in other words develops a new approach to managing the lifecycle of the computer network, from its pre-implementation design to fault management to growth and decline as traffic ebbs and flows. What is needed is a unified approach encompassing four areas of computer networking traditionally addressed separately: network design, tuning, management, and operations (including routing).

Toward this end, we can identify certain well-defined events which punctuate the lifecycle of a computer network. First of all, there is the initial design and implementation; this is unique because there is no existing network to consider. The next event to typically occur is a fault; thus fault detection/isolation/recovery must be considered and the servers implemented to execute the requisite tasks. Finally, as the traffic workload changes, the network itself must adapt: workload increase requires capacity expansion, while workload decrease may necessitate some capacity reduction. While the latter may seem unlikely in this time of explosive Internet growth, even the normal ebb and flow of daily commerce may impact the design of the transport infrastructure—especially provisioning communications bandwidth (see below).

We can arrange the various tasks executed in a computer network according to the frequency with which they happen. A convenient way to look at these is by their “interarrival times”. The least frequent is the design of the network; this can happen only once, since all subsequent changes to the network will have a functioning network to start with. The next most frequent activity is network tuning/redesign. This occurs approximate every three months to every three years; that is to say, every 10⁷ to 10⁸ seconds. Likewise, the events of network management occur approximately every 10³ to 10⁶ seconds (20 minutes to 11 days). If such events occur more frequently then that means the network is suffering faults more frequently than normal operations would allow. For example, Finally, network operations represents the shortest time scales of all. Consider a 1 Gbps channel, more or less the upper limit on communications today. Assuming that error correction coding (ECC) is employed then a decision must be made approximately 100,000,000 times per second as to whether a fault has occurred. Likewise, a frame with a Frame Check Sequence to be calculated will arrive from 100 to 1,000,000 times per second.

Another reason for a new approach relates to deficiencies in the OSI layered model itself. As Tanenbaum³ has pointed out, the seven layer model was itself a compromise and the fact that it has deficiencies should not come as any surprise. It has been broken at the crucial Layer 2 Layer 3 junction: the emergence of the 802.2 sublayers (Logical Link Control protocols 1, 2, and 3) really represents an eighth layer of the model. In addition, there is little consensus on the necessity of layers above the transport (Layer 4). The widespread use of Layer 2 concatenation techniques such as bridging and switching, in particular, violates the layer definitions, where concatenation of separate datalinks is supposed to be the responsibility of the Network layer (Layer 3). Finally, the division between the seven-layer model itself and the management layer which is typically depicted as running orthogonal to the protocol model: the difficulty with this approach is that, as we found in examining workload actuation of kind, layering by definition requires management. ³ Tanenbaum, A., Computer Networks, Prentice Hall, 2nd edition, 1988, p. 31

There is yet another objection to the current reductionism used in networking theory. Put simply, the functional reductionism on which is based the OSI model of network management, which decomposes it into fault management, configuration management, performance management, accounting management, and security management, is flawed. The difficulty with this “naive” reductionism is twofold:

overlapping/replicated servers not coordinated

missing tasks obscured by the confusion

Another way of saying this is that the decomposition is neither orthogonal nor complete. For example, we need configuration management to effect fault and performance management. In addition, routing is coupled to performance, fault, and configuration management; protocols like IP's ARP (Address Resolution Protocol) are essentially configuration management, and so on.

As can be seen above, some areas of network management as currently defined consist of monitoring. Performance management at present is limited to collecting performance statistics (measurements); actively controlling performance, by changing the rates of arrival and/or departure, has not been more than tentatively addressed, and is in fact the focus of much of this book. Configuration management is dedicated to maintaining information on the servers in the network, and as such performs a monitoring task. Fault management, on the other hand, is about both monitoring and control: monitoring to detect and isolate a fault; and control to recover the lost service capabilities (status quo ante).

The advantages of the present invention can be summarized as follows: Less unplanned, uncoordinated redundancy in the implementation; Encompasses the lifecycle of an internet within one unifying framework; Defines a new vocabulary—consistent and (almost) complete

Accordingly, a need exists for a method and system for automatically, without manual effort, controlling quality of service parameters including response time, jitter, throughput, and utilization and which is independent of topology. A further need exists for a method and system which meets the above need and which automatically, without manual effort, generates end-to-end paths that minimize delay by avoiding congestion to the greatest extent possible without incurring unstable routing dynamics, especially large oscillations in routing. A further need exists for a method and system which meets the above need which is independent of the mix of traffic and protocols used in the computer communications network. A further need exists for a method and system which meets the above need without requiring modification of the hardware and software in the intermediate nodes in computer networks. A further need exists for a method and system which meets the above need without requiring proprietary protocols. A further need exists for a method and system which meets the above need without consuming excessive amounts of the network's bandwidth. A further need exists for a method and system which meets the above need without excessive computation and is therefore tractable to realtime, on-line optimization. A further need exists for a method and system which meets the above need and which utilizes a large percentage of the links in the network. A further need exists for a method and system which meets the above need and which can be used by content-caching applications to determine the optimal locations for content-caches to which web or similar requests can be redirected. A further need exists for a method and system which meets the above need and which can be used to provide input on traffic and utilization patterns and trends to capacity planning tools. A further need exists for a method and system which meets the above need and which can be used to identify links and/or intermediate nodes of a computer communications network that at certain times have either a deficit or surplus of bandwidth to a bandwidth trading tool which will either buy additional bandwidth or make available the surplus capacity for resale to carry third party traffic.

### OBJECTS AND SUMMARY OF INVENTION

It is a general object of the present invention to provide a method and system for automatically controlling quality of service variables including response time, jitter, throughput, and utilization and availability variables including reliability and maintainability that overcomes the aforementioned short comings of the prior art.

It is another object of the present invention to actuate quality of service variables by automatically balancing traffic workload and bandwidth in communication networks.

It is a further object of the present invention to actuate quality of service variables by enabling the realization of self-tuning computer networks through the provision of traffic intensity and utilization state information to capacity planning tools that seek to adjust traffic and bandwidth.

It is a further object of the present invention to actuate quality of service variables by determining when certain links and/or intermediate nodes of a computer communications network have a deficit or surplus of bandwidth and to make this information available to a bandwidth trading tool which will either buy additional bandwidth or make the surplus bandwidth available for resale to carry third party traffic.

The foregoing and other objects of the invention are achieved by monitoring the bandwidth and traffic state of the computer network. This provides information for controlling the quality of service variables. The control is achieved by a combination of (1) by determining when the network's topology and/or bandwidth should be changed to improve performance, and (2) by identifying local bandwidth surpluses or deficits as well as their persistence to enable bandwidth trading and/or network redesign.

### BRIEF DESCRIPTION OF THE DRAWINGS

The foregoing and other objects of the present invention will be more clearly understood from the following description when read in conjunction with the accompanying drawings, of which:

FIG. 1 shows a schematic diagram of an exemplary computer system used to perform steps of the present method in accordance with one embodiment of the present invention.

FIG. 2 shows a schematic representation of a system for monitoring and controlling the quality of service of a computer communication network consisting of links, intermediate nodes, and queues in the intermediate nodes, along with a device designated the Automatic Network Management Computer (ANMC), a device designated the content cache, a device designated the content cache manager, and a device designated the bandwidth manager.

FIG. 3 is a flow chart indicating steps performed in accordance with one embodiment of the present invention to monitor network bandwidth and traffic loads, to automatically balance bandwidth and traffic loads.

### DESCRIPTION OF PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their meaning and intention to others skilled in the art. In the present application, a procedure, logic block, process, etc., is conceived to be a selfconsistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing”, “downloading”, “prompting”, “running” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical, mechanical, and analogue computers.

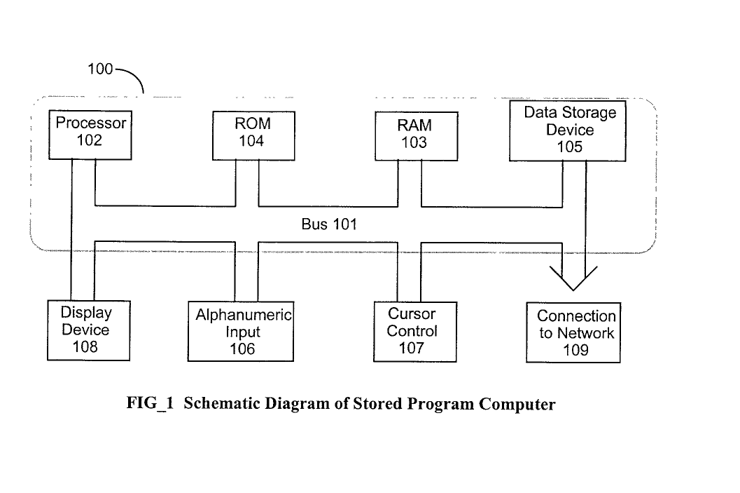

With reference now to FIG. 1, portions of the present method and system are comprised of computer-readable and computer-executable instructions which reside, for example, in computer-usable media of a computer system. FIG. 1 illustrates an exemplary computer system 100 used to perform the present invention. It is appreciated that system 100 is exemplary only and that the present invention can operate within a number of different computer systems including general purpose networked computer systems, embedded computer systems, and stand alone computer systems. Furthermore, as will be described in detail, the components of computer 100 reside, for example, in an intermediate device (e.g., automatic network management computer) of the present system and method. Additionally, computer system 100 is well adapted having computer readable media such as, for example, a floppy disk, a compact disc, and the like coupled thereto. Such computer readable media are not shown coupled to computer system 100 for purposes of clarity.

System 100 includes an address/data bus 101 for communicating information, and a central processor unit 102 coupled to bus 101 for processing information and instructions. Central processor unit 102 may be an 80x86family microprocessor or any other type of processor. Computer system 100 also includes data storage features such as a computer usable volatile RAM 103, e.g., random access memory (RAM), coupled to bus 101 for storing information and instructions for central processor unit 102, computer usable nonvolatile memory 104, e.g., read only memory (ROM), coupled to bus 101 for storing static information and instructions for the central processor unit 102, and a data storage unit 105 (e.g., a magnetic or optical disk and disk drive) coupled to bus 101 for storing information and instructions. System 100 of the present invention also includes an optional alphanumeric input device 106, which includes alphanumeric and function keys, is coupled to bus 101 for communicating information and command selections to central processing unit 102. System 100 also includes an optional display device 108 coupled to bus 101 for displaying information. Additionally, computer system 100 includes feature 109 for connecting computer system 100 to a network, e.g., a local area network (LAN) or a wide area network (WAN).

Referring still to FIG. 1, optional display device 108 may be a liquid crystal device, cathode ray tube, or other display device suitable for creating graphic images and alphanumeric characters recognizable to a user. Optional cursor control device 107 allows the computer user to dynamically signal the two dimensional movement of a visible symbol (cursor) on a display screen of display device 108. Many implementations of cursor control device 107 are known in the art including a mouse, trackball, touch pad, joystick or special keys on alphanumeric input device 106 capable of signaling movement of a given direction or manner of displacement. Alternatively, it is appreciated that a cursor can be directed and/or activated via input from alphanumeric input device 106 using special keys and key sequence commands. The present invention is also well suited to directing a cursor by other means such as, for example, voice commands. A more detailed discussion of the method and system embodiments are found below.

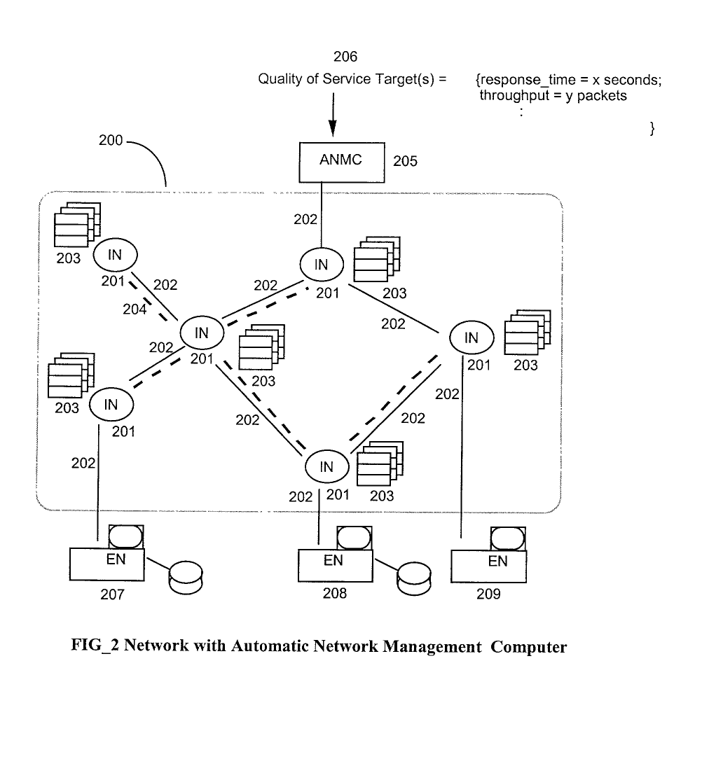

FIG. 2 is a schematic representation of a system for monitoring and controlling the quality of service of a network 200 where the number N of intermediate nodes 201 is six and the number L of links 202 is six; these are arranged in what is known as the “fish” topology. The intermediate nodes 201 may be MPLS label-switched routers (LSRs), ATM switches, layer 2 bridges, etc. Each intermediate node 201 (IN) has associated with it a set of queues 203. Also shown is a spanning tree 204 used to forward traffic between INs; the spanning tree is stored in memory of the INs 201. The network includes an Automatic network management Computer 205 (ANMC), that collects measurements of the queue sizes from the intermediate nodes in the communications network. The ANMC 205 may contain, for example, the features of computer system 100 described above in detail in conjunction with FIG. 1. The ANMC is connected via feature 109 to either a WAN or LAN link, which is connected either directly or indirectly to computer communications network 200.

The ANMC 205 may receive quality of service targets 206 from a user such as a network operator using an input device 106. These targets are specified in terms of the response time, throughput, jitter, etc. The ANMC 205 attempts to attain these by actuating the network's traffic flows (following the 22 steps outlined below in flowchart 400). For purposes of illustration only one ANMC 205 is depicted but nothing in this invention precludes a distributed implementation, where multiple ANMCs would have either disjoint or overlapping regions of the network that they each monitor and control with interANMC coordination.

FIG. 2 also includes a content cache 207 and content cache manager 208 in two end nodes (ENs) attached via links 202 to INs 201. The content cache manager 208 is responsible for determining to which content cache 207 user requests for cached data will be sent. The bandwidth manager 209 attached via a link 202 to an IN 201 is responsible for actuating the bandwidth of the network 200, either by permanently adding or deleting bandwidth in the form of links 202 and/or INs 201 or by temporarily renting additional bandwidth from or to ₃rd party networks.

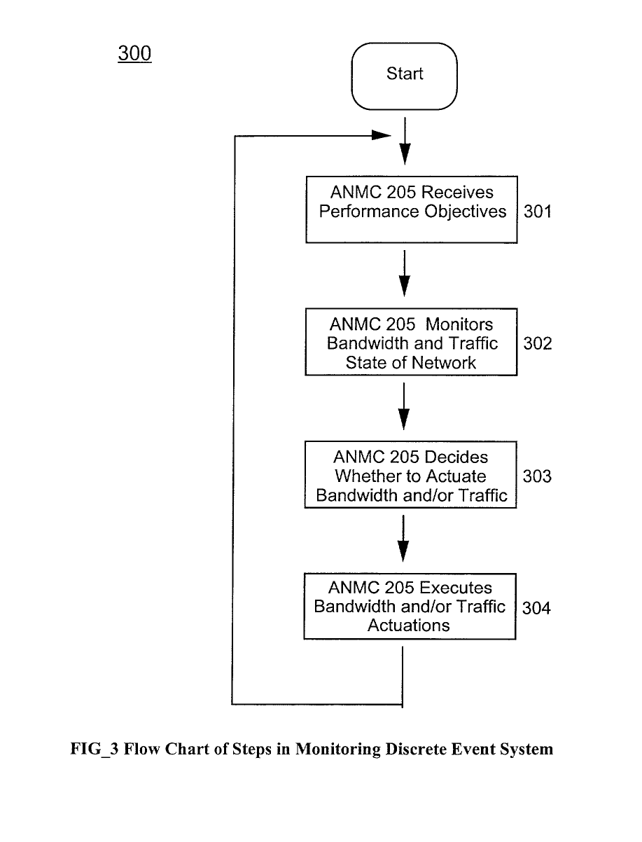

With reference now to the flowchart 300 of FIG. 3, the steps performed by the present invention to achieve quality of service is described. Flowchart 300 includes processes of the present invention which, in one embodiment, are carried out by a processor or processors under the control of computer readable and computer executable instructions. The computer readable and computer executable instructions reside, for example, in data storage features such as computer usable volatile memory 103 and/or computer usable non-volatile memory 104 of FIG. 1. The computer readable and computer executable instructions are used to control or operate in conjunction with, for example, central processing unit 102. Although specific steps are disclosed in flowchart 300 of FIG. 3, such steps are exemplary. That is, the present invention is well suited to performing various other steps or variations of the steps in FIG. 3.

In step 301 the ANMC 205 establishes an objective to be attained for example a range of acceptable response times, server utilizations and traffic intensities, or other parameters. In step 302 the ANMC 205 monitors the arrival of traffic and its servicing by the network's links. In step 303 the ANMC 205, based on these measurements and/or estimates, decides the intervention (if any) to optimize the network's performance. Finally, in step 304 the ANMC 205 effects the change using the available management actuators—workload and/or bandwidth.

What is claimed is:

1. A system for monitoring and controlling quality of service and availability of a discrete event system composed of a computer network and its traffic load, said system comprising:
an intermediate device, said intermediate device including memory for storing a program that monitors the condition and availability of components in the computer network, including links and intermediate nodes, and that also monitors the traffic load of the computer network, that includes said program determining whether imbalances exist between traffic load and bandwidth in said network and which determines how to optimally correct said imbalances either by buying and selling of short term bandwidth or by actuation of said network's topology and resources, including links and/or intermediate node capacities, and downloading said bandwidth actuations to bandwidth managers in the computer communications network; and
a set of traffic actuation devices, said devices including intermediate nodes responsible for relaying traffic between links in the computer communications network, including cache content managers responsible for deciding where to locate content caches in the computer communications network and when to have each content cache active, including bandwidth managers responsible for adding or deleting bandwidth in the computer communications network either temporarily or permanently.

2. A system as described in claim 1 wherein said intermediate device is a computer system.

3. A system as described in claim 1 wherein said intermediate device is an automatic network management computer.

4. A system as described in claim 1 wherein said intermediate device collects bandwidth and traffic statistics from intermediate nodes in the computer communications network that is being managed.

5. A system as described in claim 1 wherein said intermediate device determines the times and locations of bandwidth imbalances in the computer communications network and their persistence.

6. A system as described in claim 1 wherein said intermediate device actuates the traffic intensity by downloading the times and locations of the bandwidth imbalances found in claim 5 to a bandwidth manager in the computer communications network.

7. An intermediate device for monitoring and controlling quality of service and availability of a discrete event system composed of a computer communications network and its traffic load, said intermediate device comprising:
an intermediate device, said intermediate device including memory for storing a program that monitors the condition and availability of components in the computer network, including links and
intermediate nodes, and that also monitors the traffic load of the computer network, that includes said program determining whether imbalances exist between traffic load and bandwidth in said network and which determines how to optimally correct said imbalances either by buying and selling of short term bandwidth or by actuation of said network's topology and resources, including links and/or intermediate node capacities, and downloading said bandwidth actuations to bandwidth managers in the computer communications network;

8. A system as described in claim 7 wherein said intermediate device is a computer system.

9. A system as described in claim 7 wherein said intermediate device is an automatic network management computer.

10. A system as described in claim 7 wherein said monitoring and controlling causes the quality of service and availability variables for the discrete event system to improve.

11. A method for monitoring and controlling the quality of service and availability variables for a discrete event system composed of a computer communications network and its traffic load, said method comprising the steps of:
(a) Establish an objective to be attained for example a range of acceptable response times, server utilizations and traffic intensities, or other parameters; and
(b) Monitor the arrival of traffic and its servicing by the network's links; and
(c) Based on these measurements and/or estimates, decide the intervention (if any) to optimize the network's performance; and
(d) Effect the change using the available management actuators—workload and/or bandwidth.

12. A method as described in claim 11 wherein step (a) comprises establishing an objective to be attained for example a range of acceptable response times, server utilizations and traffic intensities, or other parameters and storing them in memory of a computer system.

13. A method as described in claim 11 wherein step (a) comprises establishing an objective to be attained for example a range of acceptable response times, server utilizations and traffic intensities, or other parameters and storing them in memory of an automatic network management computer.

14. A method as described in claim 11 wherein step (b) comprises monitoring the arrival of traffic and its servicing by the network's links and storing them in memory of a computer system.

15. A method as described in claim 11 wherein step (b) comprises monitoring the arrival of traffic and its servicing by the network's links and storing them in memory of an automatic network management computer.

16. A method as described in claim 11 wherein step (c) comprises deciding the intervention (if any) to optimize the network's performance and storing this in memory of a computer system.

17. A method as described in claim 11 wherein step (c) comprises deciding the intervention (if any) to optimize the network's performance and storing this in memory of an automatic network management computer.

18. A method as described in claim 11 wherein step (d) comprises effecting the change using the available management actuators—workload and/or bandwidth, and storing these changes in memory of a computer system.

19. A method as described in claim 11 wherein step (d) comprises effecting the change using the available management actuators—workload and/or bandwidth, and storing these changes in memory of an automatic network management computer.

20. In a computer system having a processor coupled to a bus, a computer readable medium coupled to said bus and having stored therein a computer program that when executed by said processor causes said computer system to implement a method for managing quality of service and availability in a computer communications network, said method comprising the steps of:
(a) Establish an objective to be attained for example a range of acceptable response times, server utilizations and traffic intensities, or other..
(b) Monitor the arrival of traffic and its servicing by the network's links; and
(c) Based on these measurements and/or estimates, decide the intervention (if any) to optimize the network's performance; and
(d) Effect the change using the available management actuators—workload and/or bandwidth.

21. A computer readable medium as described above in claim 20 wherein step (a) of said computer implemented method stored on said computer readable medium comprises establishing an objective to be attained for example a range of acceptable response times, server utilizations and traffic intensities, or other parameters and storing them in memory of a computer system.

22. A computer readable medium as described above in claim 20 wherein step (a) of said computer implemented method stored on said computer readable medium comprises establishing an objective to be attained for example a range of acceptable response times, server utilizations and traffic intensities, or other parameters and storing them in memory of an automatic network management computer.

23. A computer readable medium as described above in claim 20 wherein step (b) of said computer implemented method stored on said computer readable medium comprises monitoring the arrival of traffic and its servicing by the network's links and storing them in memory of a computer system.

24. A computer readable medium as described above in claim 20 wherein step (b) of said computer implemented method stored on said computer readable medium comprises monitoring the arrival of traffic and its servicing by the network's links and storing them in memory of an automatic network management computer.

25. A computer readable medium as described above in claim 20 wherein step (c) of said computer implemented method stored on said computer readable medium comprises deciding the intervention (if any) to optimize the network's performance and storing this in memory of a computer system.

26. A computer readable medium as described above in claim 20 wherein step (c) of said computer implemented method stored on said computer readable medium comprises deciding the intervention (if any) to optimize the network's performance and storing this in memory of an automatic network management computer.

27. A computer readable medium as described above in claim 20 wherein step (d) of said computer implemented method stored on said computer readable medium comprises effecting the change using the available management actuators—workload and/or bandwidth, and storing these changes in memory of a computer system.

28. A computer readable medium as described above in claim 20 wherein step (d) of said computer implemented method stored on said computer readable medium comprises effecting the change using the available management actuators—workload and/or bandwidth, and storing these changes in memory of an automatic network management computer.

29. A system for monitoring and controlling quality of service and availability in a communications comprising,
a processor including memory for storing an automatic network management program,
said processor configured to sample the bandwidth of network components and level of traffic and processing said size measurements to produce estimates of any imbalances between bandwidth and traffic.
said processor being further configured to used said imbalances to control the performance of the network.

30. A system as in claim 29 in which said processor is configured to provide bandwidth and traffic state information to capacity planning tools that seek to adjust traffic and bandwidth.

31. A system as in claim 29 in which said processor is additionally configured to determine when certain links and/or intermediate nodes of the network have surplus bandwidth or a bandwidth deficit and the level of persistence of such bandwidth imbalances and when such imbalances should be actuated using either a bandwidth trading tool which will remedy or purchase bandwidth to actuate bandwidth deficits and/or make available surplus capacity for resale to third party traffic, or when such imbalances should be actuated by actuating the network's topology and/or bandwidth.
